(19) United States
(12) Patent Application Publication
(10) Pub. No.: US 2010/0216397 A1
(43) Pub. Date: Aug. 26, 2010

(54) ELECTRONIC APPARATUS, EXPANSION APPARATUS AND ELECTRONIC APPARATUS SYSTEM

(75) Inventor: Nobuaki Takasu, Akishima-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/714,289

(22) Filed: Feb. 26, 2010

(30) Foreign Application Priority Data
Feb. 26, 2009 (JP) 2009-044767

(51) Int. Cl. H04B 5/00

(52) U.S. Cl. 455/41.1

(57) ABSTRACT

According to one embodiment, an electronic apparatus includes electromagnetic field induction electrodes and wireless communication modules which executes wireless communication of an electromagnetic field induction transmission system using the electromagnetic field induction electrodes. The electromagnetic field induction electrodes are next to each other and output electromagnetic waves with coverage areas that do not overlap each other.

### CROSS-REFERENCE TO RELATED APPLICATIONS

This application is based upon and claims the benefit of priority from Japanese Patent Application No. 2009-044767, filed Feb. 26, 2009, the entire contents of which are incorporated herein by reference.

### BACKGROUND

1. Field

One embodiment of the invention relates to a technique for efficiently utilizing a frequency band which is suitable for an electronic apparatus system constituted of an electronic apparatus such as a notebook computer and an expansion apparatus such as a port replicator, and is associated with wireless communication between the electronic apparatus and expansion apparatus.

2. Description of the Related Art

In recent years, battery-powered portable personal computers (notebook computers) have become widely used. Further, expansion apparatuses such as port replicators and docking stations to each of which a notebook computer can be detachably attached are also widely used. By using these apparatuses in combination, it becomes possible for a user in, for example, an office, to attach a notebook computer to an expansion apparatus and utilize the notebook computer functions expanded to the same level as those of a desktop computer; and, conversely, when out of the office, to carry the notebook computer made lighter by its being detached from the expansion apparatus.

Further, recently, various mechanisms for enhancing the convenience/efficiency during data transmission/reception, such as connecting a notebook computer and expansion apparatus to each other by a wireless communication channel (establishing a communication link) have been proposed (see, for example, Jpn. Pat. Appin. KOKAI Publication No. 2007-150974 and the like).

In executing the wireless communication, it is important not to cause any interference with other wireless communication. Accordingly, for example, when a plurality of wireless communication operations are simultaneously executed in one room, it has been necessary to assign different frequency bands to the respective wireless communication operations.

Incidentally, in ultra-wideband (UWB) which is recently attracting attention as a wireless communication technique faster than conventional wireless communication, a large bandwidth in the frequency band that can be utilized for the wireless communication is used, and hence, when it is temporarily assumed that a plurality of communication links have been established between the notebook computer and expansion apparatus, there have been no empty channels, and the room is brought into a state where wireless communication operations other than that between the notebook computer and expansion apparatus, such as wireless communication between an audio device and speaker are inexecutable.

It should be noted that although wireless communication executed by UWB is faster than conventional wireless communication, the performance is largely lower than wired communication executed through a mechanical connection. However, in the connection of the notebook computer and expansion apparatus to each other by the mechanical connector, there has been a problem that breakage is easily caused by the repetition of connection and disconnection.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing the configuration of an electronic apparatus system according to an embodiment of the invention;

FIG. 2 is an exemplary view showing the functional blocks of each of a notebook computer and docking unit constituting the electronic apparatus system of the embodiment;

FIG. 3 is a side view of the notebook computer and docking unit in a state (docked state) where the computer is attached to the docking unit in the electronic apparatus system of the embodiment in a first example;

FIG. 4 is a top view of the notebook computer and docking unit in the state (docked state) where the computer is attached to the docking unit in the electronic apparatus system of the embodiment in the first example;

FIG. 5 is a side view of the notebook computer and docking unit in a state (docked state) where the computer is attached to the docking unit in the electronic apparatus system of the embodiment in a second example; and

FIG. 6 is a top view of the notebook computer and docking unit in the state (docked state) where the computer is attached to the docking unit in the electronic apparatus system of the embodiment in the second example.

### DETAILED DESCRIPTION

Various embodiments according to the invention will be described hereinafter with reference to the accompanying drawings. In general, according to one embodiment of the invention, an electronic apparatus includes electromagnetic field induction electrodes and wireless communication modules which executes wireless communication of an electromagnetic field induction transmission system using the electromagnetic field induction electrodes. The electromagnetic field induction electrodes are next to each other and output electromagnetic waves with coverage areas that do not overlap each other.

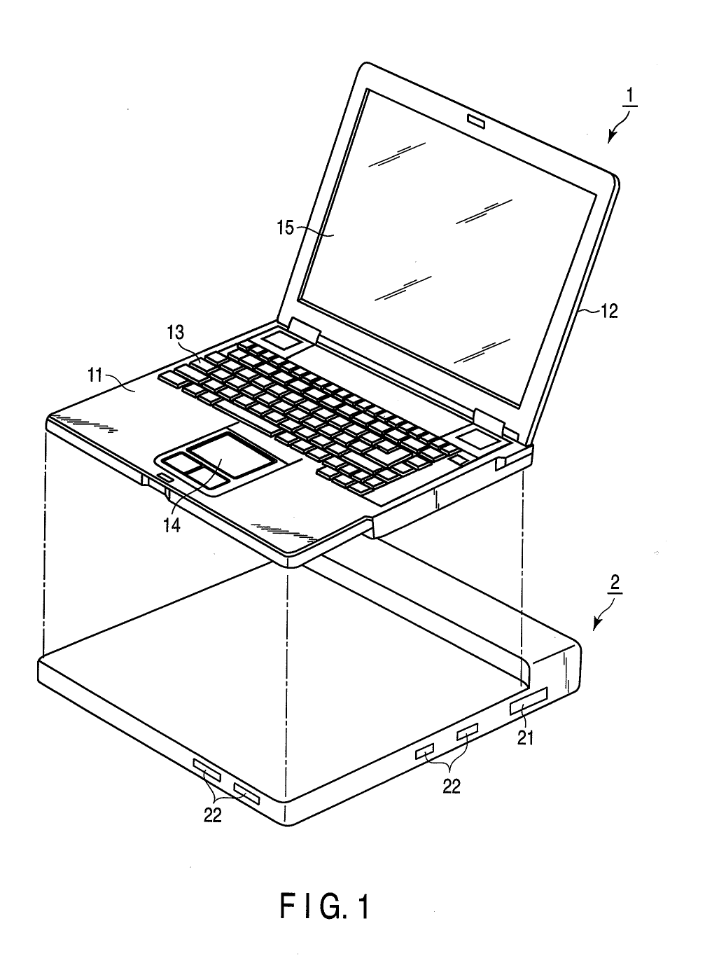

FIG. 1 is an exemplary view showing the configuration of an electronic apparatus system according to the embodiment of the invention. This electronic apparatus system is constituted of, for example, a notebook computer (electronic apparatus) 1 which can be powered by a battery, and docking unit (expansion apparatus) 2 for function-extending the notebook computer 1. The notebook computer 1 is freely attachable/detachable to/from the docking unit 2 and, in this electronic apparatus system, data transmission/reception to/from the notebook computer 1 from/to the docking unit 2 is executed by wireless communication. This electronic apparatus system is provided with a mechanism for establishing a plurality of communication links between the notebook computer 1 and docking unit 2 while minimizing the occupancy frequency band. This point will be described below in detail.

The notebook computer 1 is constituted of a main body portion 11 and a display unit 12. The main body portion 11 includes a housing of a flat box-like shape, and a keyboard 13, a touchpad 14 and the like are arranged on a top surface thereof. The display unit 12 is attached to the main body portion 11 freely rotatable between an opened position at which the top surface of the main body portion 11 is exposed and a closed position at which the top surface of the main body portion 11 is covered with the display unit 12. A display device constituted of a liquid crystal display (LCD) 15 is incorporated in the display unit 12, and a display screen of the LCD 15 is positioned at a substantially central part of the display unit 12.

The docking unit 2 also includes a housing of a flat box-like shape, and a Digital Video Interface (DVI) connector 21 and Universal Serial Bus (USB) connectors 22 for connecting various optional devices to the computer 1 are arranged on the front surface and side surface thereof.

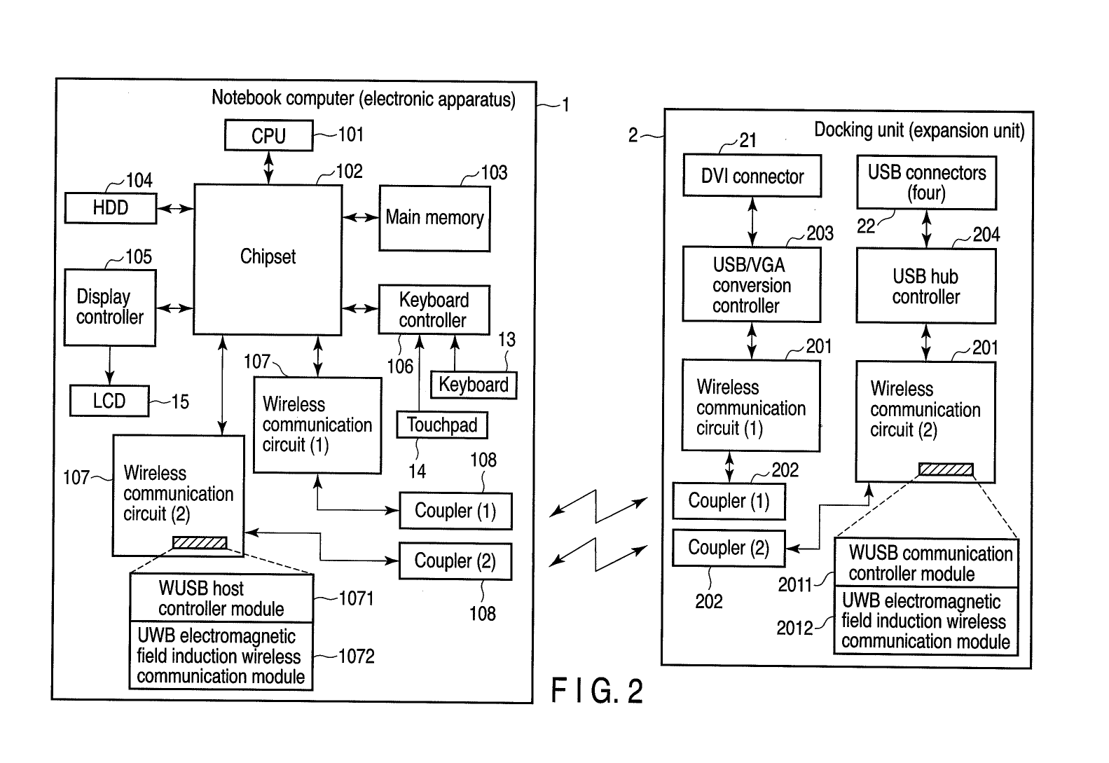

FIG. 2 is an exemplary view showing the functional blocks of each of the notebook computer 1 and docking unit 2 constituting the electronic apparatus system.

As shown in FIG. 2, the notebook computer 1 includes a CPU 101, chipset 102, main memory 103, hard disk drive (HDD) 104, display controller 105, keyboard controller 106, a plurality of wireless communication circuits 107 and a plurality of couplers 108.

The CPU 101 is a processor for managing overall control of the notebook computer 1, and executes an operating system loaded in the main memory 103 from the HDD 104 and various programs to be operated under the control of the operating system. The chipset 102 is a circuit for relaying communication between the CPU 101 and other modules. For this purpose, the chipset 102 incorporates therein various controllers for drive-controlling respective modules.

The main memory 103 is a storage medium serving as a main storage of the notebook computer 1, and stores therein various programs to be executed by the CPU 101 and various data to be used in these programs. On the other hand, the HDD 104 is a storage medium serving as an external storage of the notebook computer 1, and stores therein various programs and various data in large quantities as an auxiliary device of the main memory 103.

The display controller 105 manages the output side of a user interface provided by the notebook computer 1, and carries out display-control of screen data created by the CPU 101 on an LCD 15. On the other hand, the keyboard controller 106 manages the input side of the user interface provided by the notebook computer 1, and transmits operations of the keyboard 13 and touchpad 14 to the CPU 101.

The wireless communication circuit 107 executes high-speed wireless communication by means of UWB by using electromagnetic field induction (not by using electromagnetic field radiation). For this purpose, the wireless communication circuit 107 includes a wireless USB (WUSB) host controller module 1071, and UWB electromagnetic field induction wireless communication module 1072. The UWB electromagnetic field induction wireless communication module 1072 is a module for forming the UWB wireless communication physical layer. The WUSB host controller module 1071 provides the wireless USB function by executing wireless communication by using the UWB wireless communication physical layer formed by the UWB electromagnetic field induction wireless communication module 1072. The coupler 108 is an electromagnetic field induction electrode.

On the other hand, the docking unit 2 includes a plurality of wireless communication circuits 201, a plurality of couplers 202, a USB/video graphics array (VGA) conversion controller 203 and USB hub controller 204. The wireless communication circuit 201 also executes high-speed wireless communication by UWB by using electromagnetic field induction like the wireless communication circuit 107 of the notebook computer 1. For this purpose, the wireless communication circuit 201 includes a WUSB communication controller module 2011 and UWB electromagnetic field induction wireless communication module 2012.

The UWB electromagnetic field induction wireless communication module 2012 is a module for forming the UWB wireless communication physical layer. The WUSB communication controller module 2011 provides the wireless USB function by executing wireless communication by using the UWB wireless communication physical layer formed by the UWB electromagnetic field induction wireless communication module 2012. The coupler 202 is an electromagnetic field induction electrode.

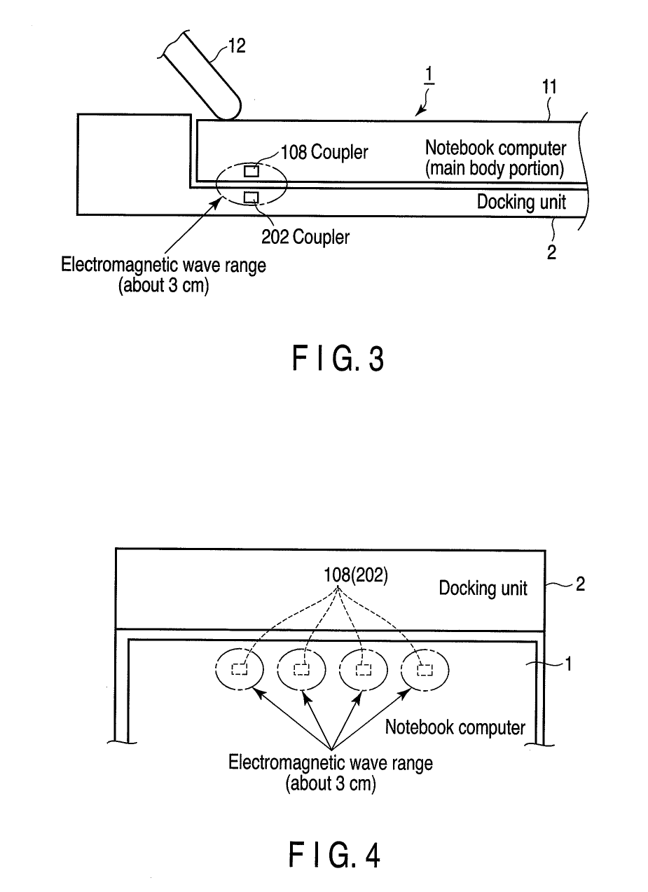

Next, a first example of an installation position of each of the couplers 108 and 202 provided in the notebook computer 1 and docking unit 2 will be described below by referring FIG. 3 and FIG. 4. FIG. 3 is a side view of the notebook computer 1 and docking unit 2 in a state (docked state) where the computer 1 is attached to the docking unit 2, and FIG. 4 is a top view of the computer 1 and docking unit 2 in the docked state.

As shown in FIG. 3, the coupler 108 on the notebook computer 1 side and coupler 202 on the docking unit 2 side are arranged at positions which are opposed to each other and are close to each other in the state where the notebook computer 1 is attached to the docking unit 2. In the first example, it is assumed that the electromagnetic wave range from each of the couplers 108 and 202 is set at about 3 cm.

Further, as shown in FIG. 4, on each of the notebook computer 1 side and docking unit 2 side, the couplers 108 or 202 are arranged in such a manner that the electromagnetic wave ranges do not overlap each other, i.e., in such a manner that the couplers 108 or 202 are arranged at intervals of at least larger than about 3 cm.

When the notebook computer 1 and docking unit 2 in which the couplers 108 or 202 are installed in the manner described above are docked with each other, if the same frequency band is applied to couplers 108 and 202 forming a pair, a communication link is established between these couplers. Here, in this electronic apparatus system, it is made possible to apply the same frequency band to all the pairs by arranging all the pairs of the couplers 108 and 202 adjacent to each other in such a manner that each interval between all the pairs exceeds the electromagnetic wave range.

Accordingly, it is possible, by using only one channel, to establish a plurality of communication links in a plurality of pairs of the WUSB host controller module 1071 of the notebook computer 1 and WUSB communication controller module 2011 of the docking unit 2. As a result of this, it becomes possible, on the notebook computer 1 side, to simultaneously access both the USB/VGA conversion controller 203 and USB hub controller 204 of the docking unit 2, and simultaneously use the DVI connector 21 and USB connector 22. Further, it is possible to make the installation area for arranging the plurality of couplers 108 and 202 small by making it possible to arrange the couplers as close as possible to each other by shortening the electromagnetic wave range from each coupler.

In UWB communication using the electromagnetic field radiation, the communication distance extends up to several meters, and hence only about three channels can be used in the same place. Even if a case where each pair can use only one channel is assumed, only three pairs can coexist.

Conversely, in this electronic apparatus system in which UWB communication between the notebook computer 1 and docking unit 2 is executed by using the electromagnetic field induction, it is possible to set the communication-enabled distance between the pairs at a very short distance of, for example, 3 cm, and hence it is possible to make the number of pairs of couplers 108 and 202 corresponding to the maximum number of couplers to be installed coexist without interference with each other by using only one channel. Furthermore, it is made possible to assign the other channel to the other wireless communication in the same room such as wireless communication or the like between an audio instrument and speaker.

Further, when it is assumed that the baud rate of the communication link of each pair of the couplers 108 and 202 is 200 Mbps, and the baud rate expected when both the USB/VGA conversion controller 203 and USB hub controller 204 are simultaneously operated at the time of USB wired connection is 480 Mbps, if only one pair of connection links can be established between the notebook computer 1 and docking unit 2, the performance becomes half the expected value or less. Conversely, in this electronic apparatus system, two communication links can be simultaneously established, and hence it is possible to realize the performance similar to that at the time of the USB wired connection.

It should be noted that the case where the same frequency band is applied to all the pairs of the couplers 108 and 202 has been described above. However, the invention is not limited to the above case, and various applications such as alternately assigning the same channel to every other pair, by using two channels, so that different frequency bands can be assigned to adjacent pairs and the like are naturally possible.

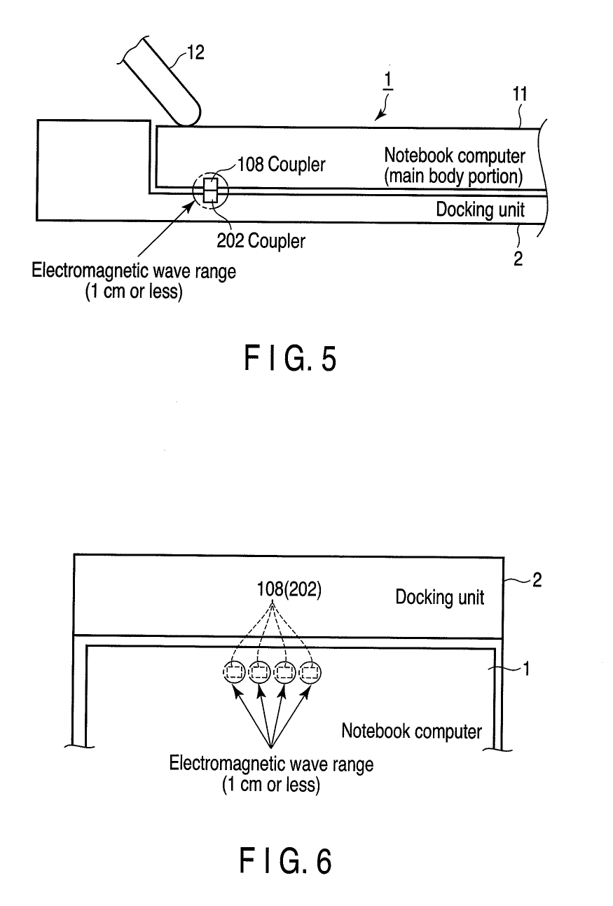

Subsequently, a second example of the installation position of each of the couplers 108 and 202 provided in the notebook computer 1 and docking unit 2 will be described below by referring to FIG. 5 and FIG. 6. FIG. 5 is a side view of the notebook computer 1 and docking unit 2 (in the docked state) in the state where the computer 1 is attached to the docking unit 2, and FIG. 6 is a top view of the notebook computer 1 and docking unit 2 in the docked state.

In the electromagnetic field induction communication, the communication is enabled even in the state where the couplers are made in contact with each other. Thus, in the second example, as shown in FIG. 5, the couplers 108 and 202 are arranged in the state where the couplers 108 and 202 are exposed from the peripheral walls of the housings of the notebook computer 1 and docking unit 2 in such a manner that the couplers 108 and 202 are in contact with each other in the state where the notebook computer 1 is attached to the docking unit 2. By installing the couplers 108 and 202 in the manner described above, it is possible to lower the output power, and further narrow the electromagnetic wave range to a value substantially equal to the size of the couplers 108 and 202, e.g., about 1 cm.

Then, it becomes possible to narrow the intervals between the pairs of the couplers 108 and 202 as shown in FIG. 6, and hence further lessening of the installation area to be secured is realized.

In the case of the second example, although the couplers 108 on the notebook computer 1 side and couplers 202 on the docking unit 2 side are brought into physical contact with each other, the possibility of breakage of the couplers due to repetitive attachment/detachment being caused is unlimitedly small as compared with the mechanical connector connection. It should be noted that in the case of the first example, it is sufficient if the couplers 108 and 202 are made close to each other within the electromagnetic wave communication-enabled range, and hence it is possible to install the couplers 108 and 202 in the housing peripheral wall parts of the notebook computer 1 and docking unit 2 so that the couplers may not be exposed to the outside. Accordingly, it is further possible to completely eliminate the possibility of the breakage of the couplers due to repetitive attachment/detachment.

As has been described above, according to this electronic apparatus system, it becomes possible to simultaneously execute a plurality of high-speed wireless communication operations between the notebook computer 1 (electronic apparatus) and docking unit 2 (expansion apparatus) while minimizing the occupancy bandwidth in the frequency band that can be utilized for the wireless communication.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus comprising:
electromagnetic field induction electrodes; and
wireless communication modules configured to wirelessly communicate on an electromagnetic field induction transmission system using the electromagnetic field induction electrodes,
wherein the electromagnetic field induction electrodes are next to each other and are configured to output electromagnetic waves with coverage areas that do not overlap with each other.

2. The electronic apparatus of claim 1, wherein the wireless communication modules are configured to use the same frequency band.

3. The electronic apparatus of claim 1, wherein the electromagnetic field induction electrodes are on a main body peripheral wall, exposed to the outside, and configured to be into contact with electromagnetic field induction electrodes of a communication counterpart.

4. The electronic apparatus of claim 1, wherein the electromagnetic field induction electrodes are in a main body peripheral wall, not exposed to the outside while facing electromagnetic field induction electrodes of a communication counterpart.

5. An expansion apparatus comprising:
a detachable connector connected a main body apparatus comprising first electromagnetic field induction electrodes;
second electromagnetic field induction electrodes configured to be paired with the first electromagnetic field induction electrodes; and
wireless communication modules configured to wirelessly communicate on an electromagnetic field induction transmission system using the second electromagnetic field induction electrodes,
wherein the second electromagnetic field induction electrodes are next to each other in a peripheral wall of the connector on a side opposite to the first electromagnetic field induction electrodes in the main body peripheral wall of the main body apparatus when the connector is connected to the main body apparatus, and the second electromagnetic field induction electrodes are configured to output electromagnetic waves with coverage areas that do not overlap with each other.

6. The expansion apparatus of claim 5, wherein the wireless communication modules are configured to use the same frequency band.

7. The expansion apparatus of claim 5, wherein the second electromagnetic field induction electrodes in the peripheral wall of the connector are exposed to the outside and configured to be into contact with the first electromagnetic field induction electrodes.

8. The expansion apparatus of claim 5, wherein the second electromagnetic field induction electrodes in the peripheral wall of the connector are not exposed to the outside while facing the first electromagnetic field induction electrodes.

9. An electronic apparatus system comprising a main body apparatus and a detachable expansion apparatus connected to the
main body apparatus, wherein
the main body apparatus comprises:
first electromagnetic field induction electrodes; and
first wireless communication modules configured to wirelessly communicate on an electromagnetic field induction transmission system using the first electromagnetic field induction electrodes,
the first electromagnetic field induction electrodes are next to each other and configured to output electromagnetic waves output with coverage areas that do not overlap with each other, and
the expansion apparatus comprises:
a detachable connector connected to the main body apparatus;
second electromagnetic field induction electrodes configured to be paired with the first electromagnetic field induction electrodes; and
wireless communication modules configured to wirelessly communicate on the electromagnetic field induction transmission system using the second electromagnetic field induction electrodes,
wherein the second electromagnetic field induction electrodes are next to each other in a peripheral wall of the connector on a side opposite to the first electromagnetic field induction electrodes in the main body peripheral wall of the main body apparatus when the connector is connected to the main body apparatus, and the second electromagnetic field induction electrodes are configured to output of electromagnetic waves output with coverage areas that do not overlap with each other.

10. The electronic apparatus system of claim 9, wherein the first wireless communication modules and second wireless communication modules are configured to use the same frequency band.

11. The electronic apparatus system of claim 9, wherein the first electromagnetic field induction electrodes on the main body peripheral wall and the second electromagnetic field induction electrodes on the peripheral wall of the connector are exposed to the outside and configured to contact with each other.

12. The electronic apparatus system of claim 9, wherein the first electromagnetic field induction electrodes in the main body peripheral wall and the second electromagnetic field induction electrodes in the peripheral wall of the connector are not exposed to the outside while facing each other.
